(19) United States
(12) Patent Application Publication
(10) Pub. No.: US 2026/0143164 A1
(43) Pub. Date: May 21, 2026

(54) OVER-COMPLETE TRANSFORM DESIGN FOR VIDEO COMPRESSION

(71) Applicant: GOOGLE LLC, Mountain View, CA (US)

(72) Inventors: Bohan Li, Santa Clara, CA (US); Jingning Han, Santa Clara, CA (US); Debargha Mukherjee, Cupertino, CA (US); Yaowu Xu, Saratoga, CA (US)

(21) Appl. No.: 19/392,617

(22) Filed: Nov. 18, 2025

Related U.S. Application Data
(60) Provisional application No. 63/723,324, filed on Nov. 21, 2024.

(51) Int. Cl. H04N 19/61; H04N 19/12; H04N 19/147; H04N 19/176; H04N 19/625

(52) U.S. Cl. CPC H04N 19/61; H04N 19/12; H04N 19/147; H04N 19/176; H04N 19/625

(57) ABSTRACT

A determination is made to use an over-complete transform for decoding a block having N prediction residuals. A primary transform associated with a set of orthonormal primary bases is selected. An additional transform basis is selected. At least N+1 quantized transform coefficients are decoded from a compressed bitstream. The block is then obtained using the at least N+1 quantized transform coefficients, the primary transform, and the additional transform basis.

### CROSS REFERENCE TO RELATED APPLICATIONS

This application claims the benefit of and priority to U.S. Provisional Patent Application Ser. No. 63/723,324, filed Nov. 21, 2024, the entire disclosure of which is incorporated herein by reference.

### BACKGROUND

Digital video streams may represent video using a sequence of frames or still images. Digital video can be used for various applications including, for example, video conferencing, high definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including encoding or decoding techniques.

### SUMMARY

One aspect of the disclosed implementations relates to a method that includes determining to use an over-complete transform for decoding a block having N prediction residuals; selecting a primary transform associated with a set of orthonormal primary bases; selecting an additional transform basis; decoding at least N+1 quantized transform coefficients from a compressed bitstream; and obtaining the block using the at least N+1 quantized transform coefficients, the primary transform, and the additional transform basis.

One aspect of the disclosed implementations relates to a method for encoding video data. The method includes receiving a block of prediction residuals; selecting a primary transform having a set of primary bases; selecting an additional basis to add to the primary bases to form an over-complete set of bases; calculating quantized transform coefficients for the block of the prediction residuals using the over-complete set of bases, wherein a number of the quantized transform coefficients exceeds a number of the prediction residuals in the block, and wherein the quantized transform coefficients include an additional transform coefficient corresponding to the additional basis and primary transform coefficients corresponding to the primary bases; and encoding the quantized transform coefficients in a compressed bitstream.

One aspect of the disclosed implementations relates to a device that includes a processor. The processor is configured to determine to use an over-complete transform for decoding a block having N prediction residuals; select a primary transform associated with a set of orthonormal primary bases; select an additional transform basis; decode at least N+1 quantized transform coefficients from a compressed bitstream; and obtain the block using the at least N+1 quantized transform coefficients, the primary transform, and the additional transform basis.

These and other aspects of the present disclosure are disclosed in the following detailed description of the embodiments, the appended claims and the accompanying figures. It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

### BRIEF DESCRIPTION OF THE DRAWINGS

The description herein makes reference to the accompanying drawings described below, wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a typical video stream to be encoded and subsequently decoded.

FIG. 4 is a block diagram of an encoder according to implementations of this disclosure.

FIG. 5 is a block diagram of a decoder according to implementations of this disclosure.

FIG. 6 illustrates an example of basis functions of a transform.

FIG. 7 is a flowchart of an example of a technique for encoding video data.

FIG. 8 is a flowchart of an example of a technique for decoding video data.

### DETAILED DESCRIPTION

In video compression, lossy techniques are commonly applied to encode visual data by transforming pixel blocks into a format that reduces data size while maintaining visual fidelity. A lossy transformation of the prediction residuals can convert spatial pixel data to transform coefficients, which are subsequently quantized to reduce file size. When decompressed, the visual quality of the reconstructed image is determined by the precision and effectiveness of the transform and quantization stages.

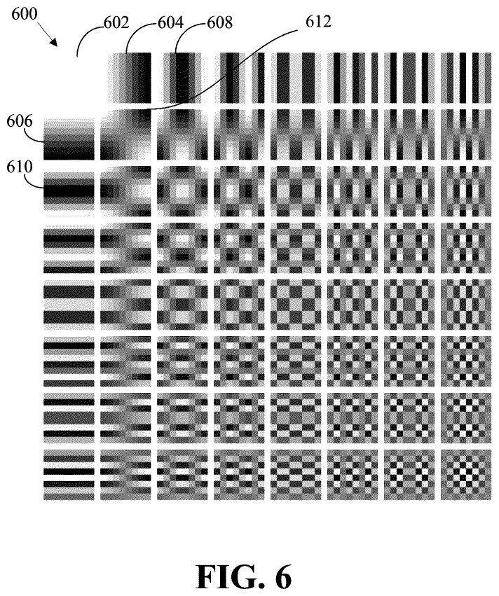

Lossy compression techniques in video coding aim to minimize the bitrate required to encode image data while preserving image quality, ideally so that any visual artifacts are not perceptible under typical viewing conditions. Traditional transforms, such as the Discrete Cosine Transform (DCT) and the Asymmetric Discrete Sine Transform (ADST), re-express each pixel block (e.g., a residual block) in terms of a set of orthonormal basis functions, such as described with respect to FIG. 6. Orthonormality means that each basis function in the set is both orthogonal (i.e., independent and uncorrelated with other basis functions) and normalized (i.e., has a unit magnitude). This property of orthonormality enables each transform coefficient to independently represent a unique component of the original data without interference from other components. In practice, this means that the projection of the data onto one basis function does not influence the projections onto others, allowing for an accurate and efficient reconstruction of the original block from the transform coefficients.

The basis functions of a transform separate components with slower spatial variation from those with faster spatial variation, enabling quantization of certain components with minimal impact on perceived image quality. In other words, a transform like the DCT or ADST decomposes a block of pixel values into different frequency components.

In conventional codecs, standard transforms like DCT or ADST are chosen, such by an encoder, based on their ability to match expected pixel characteristics within each block, such as symmetry or boundary behavior. However, this rigid selection may result in sub-optimal compression efficiency, particularly when the actual data deviates from the assumptions of the chosen transform basis. For instance, intra-predicted blocks (i.e., blocks predicted using an intra-prediction mode) often exhibit boundary conditions where the pixel residuals near the edges do not exactly meet the assumptions of ADST or DCT. The ADST may work better for intra-predicted blocks due to its asymmetric bases design. That is, the bases are not symmetric about the center of the block; instead, they exhibit a directional, one-sided pattern that aligns with gradually increasing or decreasing values across the block. Said another way, the ADST is tailored to handle residuals that exhibit gradual changes from the block boundary inward.

To elaborate further, intra-predicted blocks, which are predicted based on neighboring pixels within the same frame, often exhibit specific boundary conditions near their edges due to their proximity to reference pixels. These boundary conditions frequently do not align precisely with the assumptions underlying conventional transforms like the DCT and the ADST. For example, DCT assumes a symmetric distribution of residuals across the block, making it suitable for blocks with smooth, evenly distributed values. Conversely, ADST assumes that residuals will be near-zero at the boundary closest to the reference pixels and gradually increase across the block, making it more effective for capturing gradual transitions near edges. However, in practical scenarios, various factors such as noise, quantization effects, complex textures, and natural variations in the content can cause the residuals at the boundaries to deviate from these ideal patterns.

Implementations according to this disclosure solve problems such as these by introducing an over-complete transform design that incorporates an additional (e.g., at least one additional) basis component, enhancing the flexibility of conventional transforms. For example, and as described above, neither DCT's symmetric assumption nor ADST's asymmetric assumption alone can fully capture the residual patterns present in many intra-predicted blocks. The over-complete transform approach described herein addresses these limitations by expanding the conventional orthonormal basis set with at least one additional basis vector (to be more specific, at least one additional transform basis vector). The extra bases allow for a broader range of residual statistics to be represented, enabling more adaptable coefficient selection.

In this over-complete transform design, an added basis vector enables a codec to better capture variations in residuals, particularly in cases where the assumptions of DCT or ADST alone do not align with the actual structure of the block's residuals. The transform can adapt more closely to the specific spatial characteristics of each block without increasing data size, as it achieves a more accurate representation while using the same or fewer non-zero coefficients.

By adopting an over-complete basis, this transform design reduces the likelihood of compression artifacts, such as ringing or blurring near edges, which can occur when the chosen basis functions do not fully align with the block's actual pixel structure. Rather than requiring additional coefficients to suppress such artifacts, the transform naturally mitigates them by more effectively fitting the data. Consequently, visual quality and bitrate efficiency in compressed video streams can be improved.

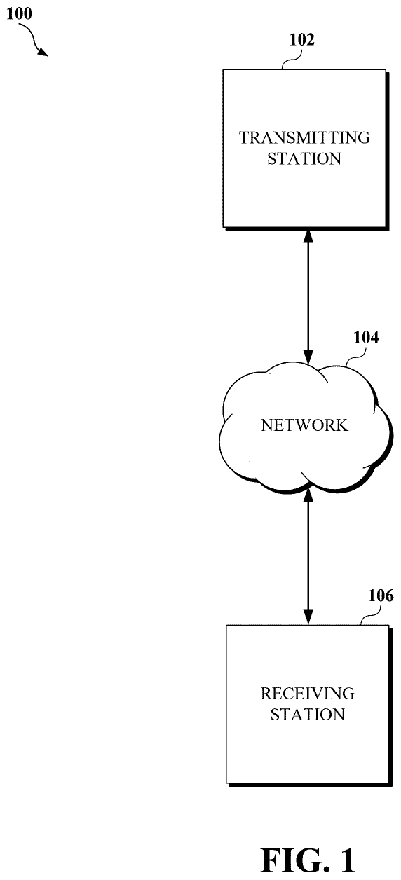

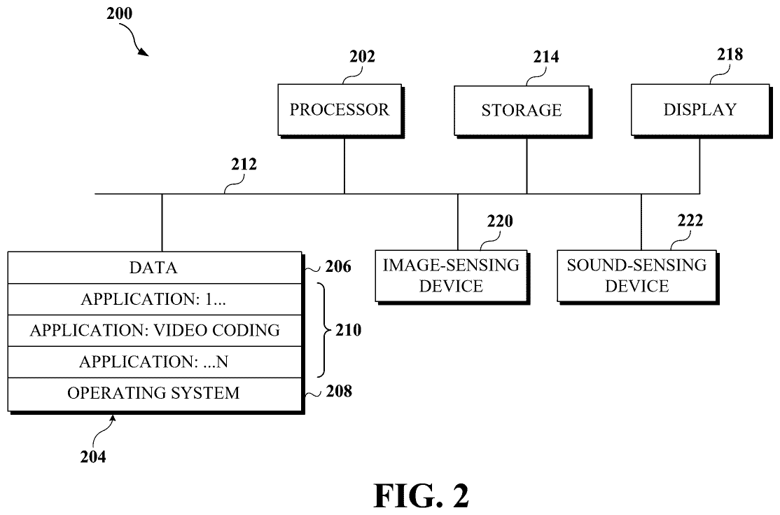

Further details of techniques for over-complete transform design for video compression are described herein with initial reference to a system in which they can be implemented. FIG. 1 is a schematic of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used (e.g., a Hypertext Transfer Protocol-based (HTTP-based) video streaming protocol).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include a video coding application that performs the techniques described herein. The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

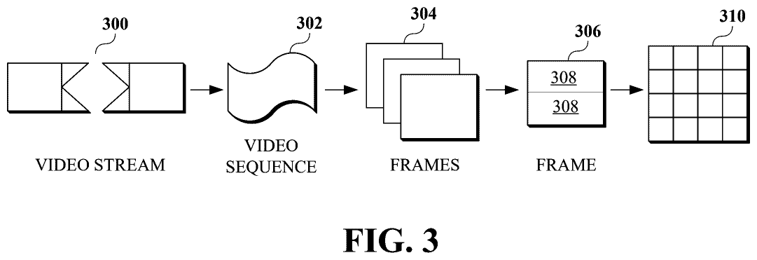

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

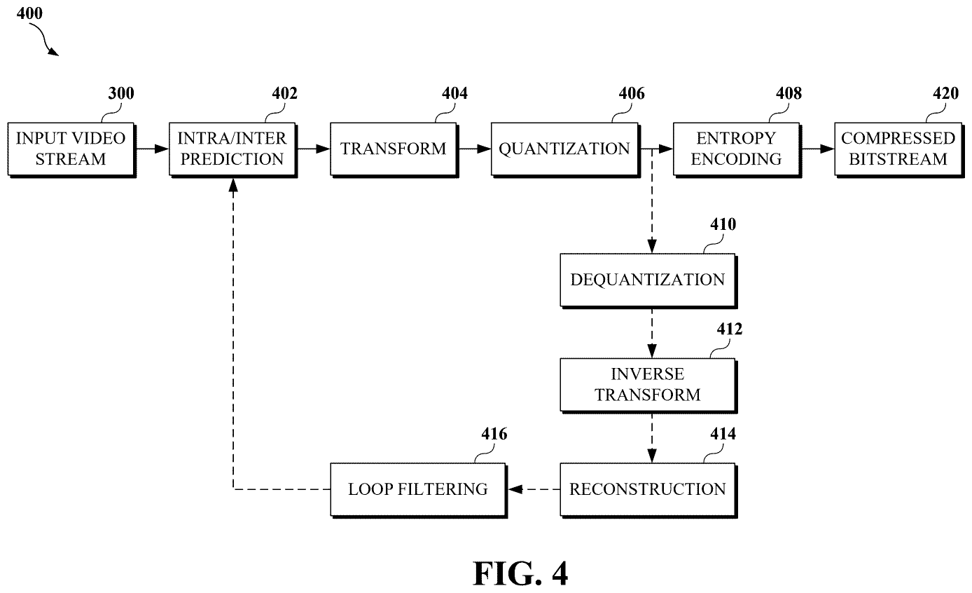

FIG. 4 is a block diagram of an encoder 400 according to implementations of this disclosure. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

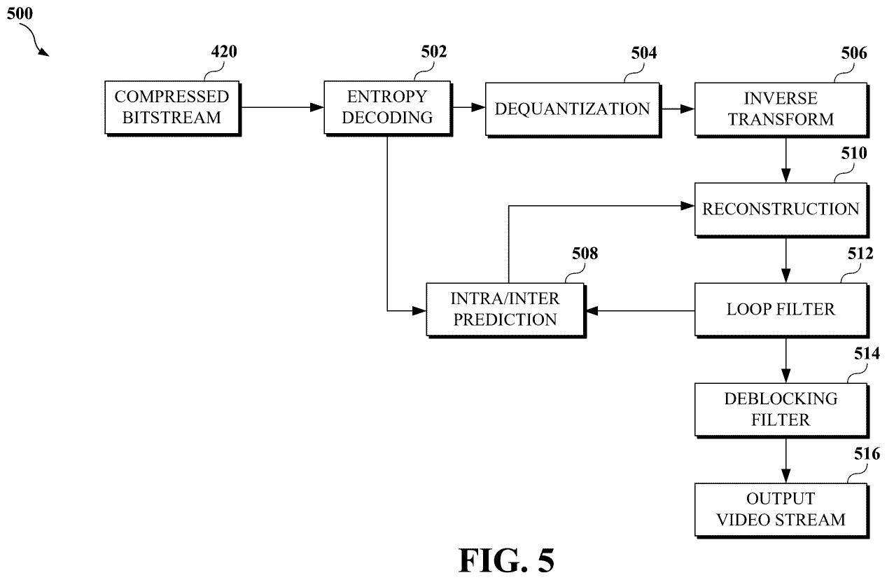

The reconstruction path (shown by the dotted connection lines) can be used to ensure that the encoder 400 and a decoder 500 (described below with respect to FIG. 5) use the same reference frames to decode the compressed bitstream 420. The reconstruction path performs functions that are similar to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400 (e.g., at the intra/inter prediction stage 402).

At the reconstruction stage 510, the prediction block can be added to the derivative residual to create a reconstructed block. The loop filtering stage 512 can be applied to the reconstructed block to reduce blocking artifacts. Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. In some implementations, the decoder 500 can produce the output video stream 516 without the deblocking filtering stage 514.

FIG. 6 illustrates an example 600 of basis functions of a transform. The example 600 illustrate the basis functions of the 2-dimensional DCT transform. As is known, given a block A of pixel values, where A is of size M×N, a transform block, T, can be generated using the formulas of equations (1):

$$\{ \begin{matrix}{T}_{pq} = {a}_{p} {a}_{q} {\sum }_{m = 0}^{M - 1} {\sum }_{n = 0}^{N - 1} {A}_{mn} cos \frac{π ( 2 m + 1 ) p}{2 M} cos \frac{π ( 2 n + 1 ) q}{2 N} \\ {a}_{p} = \{ \begin{matrix}1 / \sqrt{M} , & p = 0 \\ \sqrt{2 / M} , & 1 \leq p \leq M - 1\end{matrix} {q}_{q} = \{ \begin{matrix}1 / \sqrt{N} , & q = 0 \\ \sqrt{2 / N} , & 1 \leq q \leq N - 1\end{matrix}\end{matrix} \qquad ( 1 )$$

In the above formula, T_{pq} are the DCT (i.e., transform) coefficients of the block A. The basis functions of the example 600 are defined on 64 points (i.e., on an 8×8 grid). However, the block size (and, therefore, the corresponding basis functions) need not be 8×8. For example, if the image block is of size M×N (e.g., 12×12), then there will be M*N (e.g., 12*12=144) basis functions and, correspondingly, M*N transform coefficients in the transform block. The very first basis function, a function 602, is a constant function. The function 602, when multiplied by a coefficient value (also known as the DC coefficient), can be interpreted as the average brightness of that block.

The other DCT basis functions of the example 600 add corrections (positive or negative corrections) to the average value. For example, basis functions 604 and 606 provide approximation (i.e., corrections) of the vertical brightness variation and horizontal brightness variation, respectively. Basis function 608, 610, 612 provide the next level of correction. The basis function 608, 610, 612 provide diagonal brightness variation as well as faster brightness variation that doesn't simply cycle from bright to dark over the width of one block or the height of one block, rather the brightness variation also cycles from bright to dark to bright again.

The 2D DCT of the example 600 transformation is premised on the fact that brightness for many images doesn't vary rapidly from pixel to pixel. As such, an image is not merely a random noise of brightness (i.e., unrelated pixel values); rather, there is assumed to be a strong correlation between the brightness of one pixel and the brightness of an adjacent pixel. The DCT basis functions take the correlation into account. Typically, smoother variations are retained, and the spatial fast variation are discarded. Fast spatial variations correspond to the high frequency components, which are toward the bottom and the right of the basis functions of the example 600.

As another example, the one-dimensional (1D) DCT-2 transform is given by equations (2):

$$\{ \begin{matrix}{T}_{i} ( j ) = {ω}_{0} \sqrt{\frac{2}{N}} cos ( \frac{π \cdot i \cdot ( 2 j + 1 )}{2 N} ) \\ where {w}_{0} = ( i == 0 ) ? \sqrt{\frac{2}{N}} : 1\end{matrix} \qquad ( 2 )$$

Conventionally, each transform block can have associated therewith a transform type. The transform type can include a horizontal transform type (e.g., a kernel) to be applied to the rows of the transform block and a vertical transform type (e.g., a kernel) to be applied to the columns of the transform block, independently. A separable two-dimensional (2D) transform process can be applied to prediction residuals. For the forward transform (e.g., at an encoder), a one-directional (1D) vertical transform is first performed on each column of the input residual block, then a horizontal transform is performed on each row of the vertical transform output. For the backward transform (e.g., at a decoder), a 1D horizontal transform is first performed on each row of the input dequantized coefficient block, then a vertical transform is performed on each column of the horizontal transform output.

In an example, the transform kernels available in a codec may include four different types of transforms: the DCT, the ADST, a flipped version of the ADST (FLIPADST), and an identity transform (IDT). Each of these transforms (i.e., kernels) may be available at different points. For example, 4-, 8-, 16-, 32-, and 64-point DCT kernels may be available; 4-, 8-, and 16-point ADST and FLIPADST kernels may be available; and 4-, 8-, 16-, and 32-point identity transforms (IDTs) may be available. Again, more, fewer, or other kernels are possible.

The DCT kernel is widely used in signal compression and is known to approximate the optimal linear transform, the Karhunen-Loeve transform (KLT), for consistently correlated data. The ADST, on the other hand, approximates the KLT where one-sided smoothness is assumed and can be naturally suitable for coding, inter alia, some intra-prediction residuals. Similarly, the FLIPADST can capture one-sided smoothness from the opposite end. The IDT can be used to accommodate situations where sharp transitions are contained in the block and where neither DCT nor ADST is effective. Also, the IDT, combined with other 1-D transforms, provides the 1-D transforms themselves, therefore allowing for better compression of horizontal and vertical patterns in the residual.

Accordingly, the fixed (i.e., primary) transform types that are available may include sixteen 2D transforms comprising combinations of four 1D transforms as follows: DCT_DCT (transform rows with DCT and columns with DCT), ADST_DCT (transform rows with ADST and columns with DCT), DCT_ADST (transform rows with DCT and columns with ADST), ADST_ADST (transform rows with ADST and columns with ADST), FLIPADST DCT (transform rows with FLIPADST and columns with DCT), DCT_FLIPADST (transform rows with DCT and columns with FLIPADST), FLIPADST_FLIPADST (transform rows with FLIPADST and columns with FLIPADST), ADST_FLIPADST (transform rows with ADST and columns with FLIPADST), FLIPADST_ADST (transform rows with FLIPADST and columns with ADST), IDT (transform rows with identity and columns with identity), V_DCT (transform rows with identity and columns with DCT), H_DCT (transform rows with DCT and columns with identity), V_ADST (transform rows with identity and columns with ADST), H_ADST (transform rows with ADST and columns with identity), V_FLIPADST (transform rows with identity and columns with FLIPADST), and H_FLIPADST (transform rows with FLIPADST and columns with identity).

In a conventional orthonormal transform system, for a block having N pixels (where N can represent the total number of pixels in P×Q block (i.e., P*Q=N), the transform can be represented using N orthonormal bases. Each orthonormal basis can be represented as a vector aᵢ (where i ranges from 0 to N−1) having N elements. For any given block of pixels x (which can be arranged as a vector having N elements), the conventional transform can be expressed as a linear combination of these bases according to equation (3), where the scalar values wᵢ represent transform coefficients.

$$x = {w}_{0} \times {a}_{0} + {w}_{1} \times {a}_{1} + … + {w}_{N - 1} \times {a}_{N - 1} \qquad ( 3 )$$

In this equation (3), the scalar values wᵢ represent transform coefficients. When used at the encoder side, wᵢ may represent the original, non-quantized transform coefficients calculated from the pixel values of the block. After quantization, the wᵢ values become quantized transform coefficients, which are then encoded for transmission in a compressed bitstream. At the decoder side, the wᵢ values correspond to the dequantized transform coefficients used to reconstruct the block.

In the conventional system, these transform coefficients can be uniquely determined due to the orthonormal properties of the bases functions of a transform.

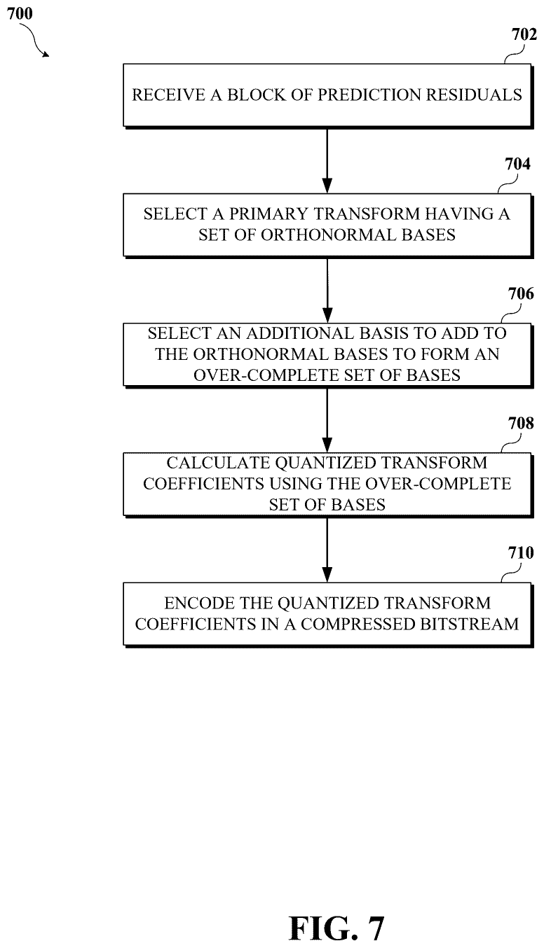

FIG. 7 is a flowchart of an example of a technique 700 for encoding video data. More specifically, the technique 700 can be used to obtain and encode a transform block from a residual block. The technique 700 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as the processor 202, may cause the computing device to perform the technique 700. The technique 700 may be implemented at least in part in the transform stage 404 of the encoder 400 of FIG. 4. The technique 700 can be implemented using specialized hardware or firmware. Multiple processors, memories, or both, may be used.

The technique 700 implements an over-complete transform design that expands upon conventional orthonormal transforms by adding at least one or more additional bases. The technique 700 extends the above described conventional approach by introducing at least one additional basis vector b to create an over-complete set of bases. For brevity, the term “additional basis” should be interpreted to mean “an additional transform basis vector.” With this additional basis b, the transform can be expressed as shown in equation (4), where w_{b} represents the transform coefficient associated with the additional basis b. Herein, w_{b} is referred to as the “additional transform coefficient” and the wᵢ's are referred as the “primary (or remaining) transform coefficients, where the transform coefficients can be quantized transform coefficients; and b is referred as the “additional basis,” and the aᵢ's are referred to as the “primary bases” of a primary transform.

$$x = {w}_{b} \times b + {w}_{0} \times {a}_{0} + {w}_{1} \times {a}_{1} + … + {w}_{N - 1} \times {a}_{N - 1} \qquad ( 4 )$$

The additional basis b can be selected in various ways, as further explained herein. For example, when the primary transform is a non-DCT transform (such as 2-D ADST, flipped 2-D ADST, 1-D ADST, or flipped 1-D ADST), the additional basis b can the DC component of the DCT transform. For example, the DC component of the DCT transform described with respect to equation (1) can be obtained by setting p=q=0.

At 702, a block of prediction residuals is received. The block may have dimensions of P×Q (e.g., P=Q). The prediction residuals can be obtained based on a prediction mode. The prediction mode can be an intra-prediction mode, an inter prediction mode, or some other mode.

At 704, a primary transform (e.g., a transform type) having a set of primary bases is selected. The primary transform can be selected based on a prediction mode used to obtain the block of prediction residuals. The primary transform can be selected from a group comprising a two-dimensional asymmetric discrete sine transform (2-D ADST), a flipped two-dimensional asymmetric discrete sine transform, a one-dimensional asymmetric discrete sine transform (1-D ADST), and a flipped one-dimensional asymmetric discrete sine transform. As such, the primary transform may be an ADST.

The selection of the primary transform may be based on characteristics of the block of prediction residuals. For example, in blocks generated through intra-prediction, the prediction residuals typically exhibit specific patterns where the residual values are expected to be near-zero at block boundaries adjacent to reference pixels (i.e., pixels of the above neighboring row and/or left neighboring column), with residual energy increasing at locations further from these reference pixels. Such characteristics are expected to align with the asymmetric nature of the ADST. However, and as already mentioned, due to factors such as quantization effects and noise in the reference pixels, the actual prediction residuals at the block boundaries may deviate from zero while still maintaining an increasing energy pattern away from the reference pixels. In such scenarios, the near-zero boundary assumption of ADST may not be satisfied, while simultaneously, the symmetric patterns assumed by other transforms such as DCT may also be violated, potentially making both transform choices sub-optimal for the given block.

To address these scenarios where conventional orthonormal transforms (i.e., the primary bases of the primary transform) may not optimally represent the prediction residuals, the technique 700 extends a selected primary orthonormal transform to create an over-complete set of bases. This extension enables the transform to accommodate a broader range of residual statistics and patterns that may not be well-represented by any single conventional transform. By combining the primary orthonormal bases of the primary transform with at least one additional basis, the technique 700 provides greater flexibility in representing various residual patterns that may occur in video coding applications.

As such, at 706, an additional basis is selected to add (i.e., is added) to the orthonormal primary bases to form an over-complete set of bases. In some implementations, when the primary transform is ADST, the additional basis may be or include a DC component of the DCT. The selection of the DC component of the DCT may be made in response to determining that the block is an intra-predicted block. Multiple additional bases may be selected to add to the primary bases, where the number of quantized transform coefficients is increased by the number of the additional bases. That is, if Y number of additional bases are added, then Y additional transform coefficients would be generated for the block.

In some implementations, the additional basis may be obtained using machine learning. For example, a machine learning model may be trained offline using a dataset of prediction residual blocks to learn optimal additional bases for various coding scenarios. The training process may analyze patterns in the prediction residuals that are not well-represented by conventional orthonormal transforms, thereby identifying bases that can better capture these residual statistics. The model may identify different residual patterns based on factors such as block size, prediction mode, quantization parameters, and coding conditions, and generate or select appropriate additional bases accordingly. The learned additional bases may augment the orthonormal bases of primary transforms by capturing residual patterns that arise frequently in specific video coding contexts, such as intra-prediction with non-zero boundary residuals. In some implementations, multiple additional bases may be learned and then applied selectively based on the characteristics of the current block being encoded, such as high residual energy at specific block boundaries or particular prediction modes.

At 708, quantized transform coefficients are calculated for the block of prediction residuals using the over-complete set of bases. The number of quantized transform coefficients exceeds the number of prediction residuals in the block. Specifically, for a block with dimensions of P×Q, the number of quantized transform coefficients is at least P*Q+1. The quantized transform coefficients include primary transform coefficients corresponding to the bases of the primary transform and an additional quantized transform coefficient corresponding to the additional basis.

Equation (3), which uses only the primary bases of a primary transform, can be uniquely solved for the transform coefficients wᵢ's. That is, there is only one set of quantized transform coefficients that satisfies the equation (3). However, due to the over-complete nature of the expanded set of bases {b, a₀, a₁, . . . , a_{N-1}}, the quantized transform coefficients {w_{b}, w₀, w₁, . . . w_{N-1}} no longer have a unique solution. Instead, there are infinite possible combinations of quantized transform coefficients that could represent the input block x.

The technique 700 can implement various ways for determining optimal transform coefficients. In one approach, the technique 700 performs a search to determine the additional transform coefficient w_{b} associated with the additional basis b. Once the additional transform coefficient is determined, the remaining coefficients can be uniquely solved. The search for the additional transform coefficient can be guided by various optimization criteria. The technique 700 may minimize a rate-distortion cost, minimize a total energy of the remaining transform coefficients, or maximize a number of zero coefficients after quantization.

A rate-distortion cost is a metric that balances coding efficiency against reconstruction quality. The rate component represents the number of bits required to encode the transform coefficients, while the distortion component represents the difference between the original block and the reconstructed block after quantization and inverse transformation. In transform coefficient optimization, a lower rate-distortion cost indicates a more efficient combination of coefficients that achieves better quality for a given bitrate, or equivalently, uses fewer bits for a given quality level.

In some implementations, for each quantized value of the additional transform coefficient, the technique 700 calculates the remaining transform coefficients (i.e., the primary transform coefficients) and a rate-distortion cost. The technique 700 then selects the quantized value of the additional transform coefficient that produces the lowest rate-distortion cost. In another implementation, for each quantized value of the additional transform coefficient, the technique 700 calculates the primary transform coefficients and determines their total energy as a sum of squared values, then selects the quantized value of the additional transform coefficient that minimizes the total energy of the primary coefficients. The sum of squared values is calculated between the primary transform coefficients and transform coefficients obtained using only the primary bases without any additional bases.

In some implementations, the search process involves evaluating integer multiples of a quantization step size within a predetermined range, where the quantization step size is determined based on a quantization parameter for the block. A quantization index refers to an integer value that represents a quantized coefficient level. For example, if the quantization step size is 10, the search evaluates coefficient values derived from quantization indices, where index 0 corresponds to value 0, index 1 corresponds to value 10, index 2 corresponds to value 20, index −1 corresponds to value −10, and index −2 corresponds to value −20. Each index represents an integer multiple of the quantization step size, determining the possible quantized values that can be transmitted in the bitstream.

After the transform coefficients are determined through these optimization processes, they undergo quantization before being transmitted in the compressed bitstream. At the decoder side, these quantized coefficients can be dequantized and used to perform an inverse transform using the same over-complete set of bases to reconstruct the original block x.

At 710, the quantized transform coefficients are encoded in a compressed bitstream. The compressed bitstream can be the compressed bitstream 420 of FIG. 4. The additional transform coefficient and the primary transform coefficients are encoded in the compressed bitstream.

The technique 700 can be implemented with various signaling mechanisms. In some implementations, the technique 700 includes encoding a flag in the compressed bitstream to explicitly signal whether the over-complete transform is being used for a particular block. In other implementations, the over-complete transform may be implicitly indicated. For example, when the coefficient w_{b} associated with the additional basis is quantized to zero, the transform automatically reduces to the conventional orthonormal transform, eliminating the need for explicit signaling in such cases.

As such, in some implementations, the technique 700 may encode a flag in the compressed bitstream indicating that the over-complete set of bases is used for the block (claim 13). If the flag has a first value (e.g., 1), then the decoder uses the over-complete set of bases to decode the block; and if the flag has a second value (e.g., 0), then the decoder only uses the primary transform to decode the block. In other implementations, no flag is encoded; instead, the decoder determines whether to use an over-complete set of bases based on the value of a first decoded quantized transform coefficient, w_{b}: if the decoded quantized additional coefficient w_{b}=0, then the decoder does not use an over-complete set of bases to decode the block. That is, if w_{b}=0, then the transform reduces to the original orthonormal bases of the primary transform.

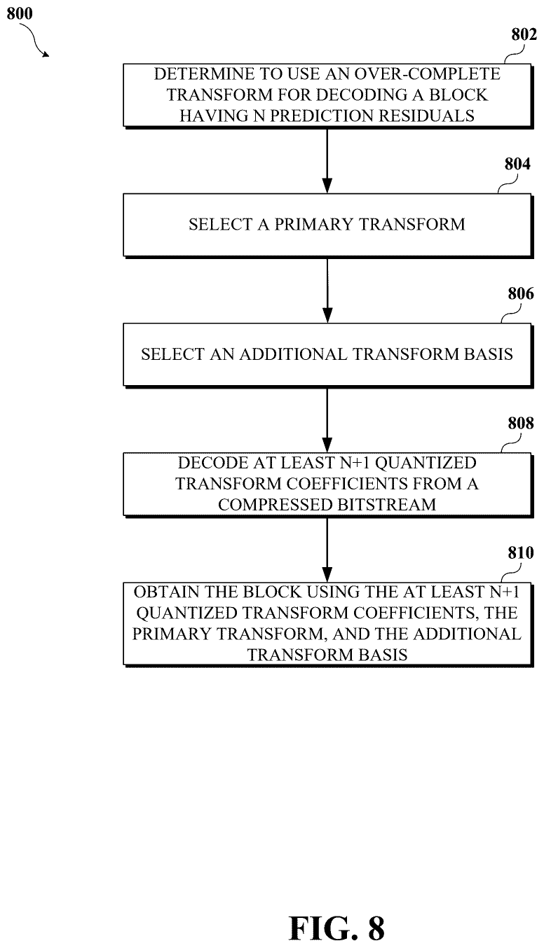

FIG. 8 is an example of a flowchart of a technique 800 for decoding video data. The technique 800 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor 202, such as a CPU, may cause the computing device to perform the technique 800. The technique 800 may be implemented in whole or in part by the inverse transform stage 506 of the decoder 500 of FIG. 5. The technique 800 can be implemented using specialized hardware or firmware. Multiple processors, memories, or both, may be used. The technique 800 implements an over-complete transform design that expands upon conventional orthonormal transforms by adding at least one or more additional bases when decoding a transform block.

At 802, a determination is made to use an over-complete transform for decoding a block having N prediction residuals. This determination can be made in different ways. In one implementation, a flag is decoded from a compressed bitstream (e.g., the compressed bitstream 420 of FIG. 5), where the flag indicates whether to use the over-complete transform. In another implementation, a first coefficient is decoded from the compressed bitstream, and the over-complete transform is used in response to the first coefficient being non-zero. In another implementation, the technique 800 may be configured to always use over-complete transform.

At 804, a primary transform associated with a set of orthonormal primary bases is selected. In some implementations, the primary transform comprises ADST. The selection of the primary transform may be based on a prediction mode used for the block.

At 806, an additional transform basis is selected. In some implementations, when the primary transform is ADST, the additional transform basis comprises a DC component of a discrete cosine transform (DCT). The DC component of the DCT may be selected as the additional transform basis in response to determining that the block was encoded using intra-prediction. In some implementations, multiple additional transform bases may be selected instead of just one additional transform basis.

At 808, at least N+1 quantized transform coefficients are decoded from a compressed bitstream. When multiple additional transform bases are used, the number of decoded coefficients is increased to N plus the number of the multiple additional transform bases.

At 810, the block is obtained using the at least N+1 quantized transform coefficients, the primary transform, and the additional transform basis. That is, the block x can be obtained using a formula similar to that given by equation (4).

For simplicity of explanation, the techniques 700 and 800 of FIGS. 7 and 8, respectively, are each depicted and described as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor (that is, the computer-readable medium can be a non-transitory computer-readable storage medium). The medium can be, for example, an electronic, magnetic, optical, electromagnetic, semiconductor device, or any other suitable mediums.

The above-described embodiments, implementations, and aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method, comprising:
determining to use an over-complete transform for decoding a block having N prediction residuals;
selecting a primary transform associated with a set of orthonormal primary bases;
selecting an additional transform basis;
decoding at least N+1 quantized transform coefficients from a compressed bitstream; and
obtaining the block using the at least N+1 quantized transform coefficients, the primary transform, and the additional transform basis.

2. The method of claim 1, wherein determining to use the over-complete transform comprises:
decoding a flag from the compressed bitstream, wherein the flag indicates whether to use the over-complete transform.

3. The method of claim 1, wherein determining to use the over-complete transform comprises:
decoding a first coefficient from the compressed bitstream; and
determining to use the over-complete transform in response to the first coefficient being non-zero.

4. The method of claim 1, wherein selecting the additional transform basis comprises:
selecting the additional transform basis in response to determining that the block was encoded using intra-prediction.

5. The method of claim 1,
wherein selecting the additional transform basis comprises:
selecting multiple additional transform bases; and
wherein decoding the at least N+1 quantized transform coefficients comprises:
decoding N plus a number of the multiple additional transform bases quantized transform coefficients.

6. A method for encoding video data, comprising:
receiving a block of prediction residuals;
selecting a primary transform having a set of primary bases;
selecting an additional basis to add to the primary bases to form an over-complete set of bases;
calculating quantized transform coefficients for the block of the prediction residuals using the over-complete set of bases,
wherein a number of the quantized transform coefficients exceeds a number of the prediction residuals in the block, and
wherein the quantized transform coefficients include an additional transform coefficient corresponding to the additional basis and primary transform coefficients corresponding to the primary bases; and
encoding the quantized transform coefficients in a compressed bitstream.

7. The method of claim 6, wherein selecting the additional basis comprises:
selecting a DC component of a DCT transform in response to determining that the block is an intra-predicted block.

8. The method of claim 6, wherein calculating the quantized transform coefficients for the block of the prediction residuals using the over-complete set of bases comprises:
searching through quantized values for the additional transform coefficient; and
calculating the primary transform coefficients based on the quantized values for the additional transform coefficient, wherein calculating the primary transform coefficients comprises:
selecting the primary transform coefficients such that a total energy of the primary transform coefficients is minimized.

9. The method of claim 8, wherein searching through the quantized values comprises:
evaluating integer multiples of a quantization step size, wherein the quantization step size is determined based on a quantization parameter for the block.

10. The method of claim 8, wherein searching through the quantized values comprises:
for each quantized value of a set of the quantized values of the additional transform coefficient:
calculating the primary transform coefficients; and
calculating a rate-distortion cost associated with the each quantized value and the primary transform coefficients; and
selecting the quantized value that produces a lowest rate-distortion cost.

11. The method of claim 8, wherein searching through the quantized values comprises:
for each quantized value of a set of the quantized values of the additional transform coefficient:
calculating the primary transform coefficients; and
determining a respective total energy of the primary transform coefficients; and
selecting the quantized value that minimizes the total energy of the primary transform coefficients.

12. The method of claim 6, further comprising:
encoding a flag in the compressed bitstream indicating that the over-complete set of bases is used for the block.

13. The method of claim 6, wherein selecting the additional basis comprises:
selecting multiple additional bases to add to the primary bases, wherein the number of quantized transform coefficients is increased by a number of the multiple additional bases.

14. The method of claim 6, wherein calculating the quantized transform coefficients comprises:
selecting the quantized transform coefficients to maximize a number of zero coefficients after quantization.

15. A device, comprising:
a processor configured to
determine to use an over-complete transform for decoding a block having N prediction residuals;
select a primary transform associated with a set of orthonormal primary bases;
select an additional transform basis;
decode at least N+1 quantized transform coefficients from a compressed bitstream; and
obtain the block using the at least N+1 quantized transform coefficients, the primary transform, and the additional transform basis.

16. The device of claim 15, wherein, to determine to use the over-complete transform, the processor is configured to:
decode a flag from the compressed bitstream, wherein the flag indicates whether to use the over-complete transform.

17. The device of claim 15, wherein, to determine to use the over-complete transform, the processor is further configured to:
decode a first coefficient from the compressed bitstream; and
determine to use the over-complete transform in response to the first coefficient being non-zero.

18. The device of claim 15, wherein, to select the additional transform basis, the processor is further configured to:
select the additional transform basis in response to determining that the block was encoded using intra-prediction.

19. The device of claim 15, wherein the processor is further configured to:
select multiple additional transform bases; and
decode N plus a number of the multiple additional transform bases quantized transform coefficients.

20. The device of claim 15, wherein, to select the additional transform basis, the processor is further configured to:
select the additional transform basis based on a prediction mode used for the block.
